(19) United States
(12) Patent Application Publication
(10) Pub. No.: US 2006/0116164 A1
(43) Pub. Date: Jun. 1, 2006

(54) System and method for divided display on multiple mobile terminals

(75) Inventor: Dae-Suk Kang, Yongin-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/284,346

(22) Filed: Nov. 21, 2005

(30) Foreign Application Priority Data
Dec. 1, 2004 (KR) 99902/2004

(51) Int. Cl. H04Q 7/20

(52) U.S. Cl. 455/557; 455/566

(57) ABSTRACT

Disclosed is a system for producing a divided display of an image using a plurality of mobile terminals, including a master mobile terminal for dividing an image into two or more pieces, displaying one of the pieces as a master image on a display section thereof and transmitting each remaining piece as a slave image; and a slave mobile terminal for receiving the slave image from the master mobile terminal and displaying the received slave image on a display section thereof.

### PRIORITY

This application claims priority to an application entitled “System and Method for Divided Display on Multiple Mobile Terminals” filed with the Korean Intellectual Property Office on Dec. 1, 2004 and assigned Serial No. 2004-99902, the contents of which are incorporated herein by reference.

### BACKGROUND OF THE INVENTION

1. Field of the Invention

The present invention relates to a system and method for providing a divided display of a single image on a plurality of mobile terminals, and more particularly to a system and method for dividing a single image to generate a master image and one or more slave images and displaying the master image on a master mobile terminal and each slave image on a slave mobile terminal.

2. Description of the Related Art

With the development of mobile communication technologies, mobile terminals have become more integrated than pre-existing ones which only provided simple voice calls, or including data communications such as GPRS, CDMA EV-DE, CDMA EV-DV, WCDMA and HSDPA. Mobile terminals capable of communicating large amounts of data can offer multimedia services such as VOD streaming broadcasts and conference calls. However, when such multimedia services are used on a mobile terminal, there exists problems in the effective display on a small display window.

Due to the tendency toward the compact-sized mobile terminals, display windows of the mobile terminals are not large enough to effectively display a selected function or service. Accordingly, users cannot fully enjoy the excitement of seeing a movie or playing a mobile game on a conventional mobile terminal having a limited sized display window.

When a movie or a TV broadcast program is played on a mobile terminal, the enjoyment of user is reduced due to the small sized display window. When playing a mobile game, the user has to concentrate on the progress of the game displayed on the small display window, which often causes eye strain or fatigue. Because of the small keypad and display window, it is difficult for two players to implement a 2-player game on a single mobile terminal without using a wireless Internet. To enhance the excitement of seeing a movie or playing a mobile game, users may separately purchase a larger display window and connect it to a mobile terminal through a wired or wireless link.

### SUMMARY OF THE INVENTION

The present invention has been made to solve at least the above-mentioned problems occurring in the prior art, and an object of the present invention is to provide a system and method for dividing a single image to be effectively displayed on a plurality of mobile terminals.

Another object of the present invention is to provide a system and method for implementing a 2-player mobile game by providing a divided display of a single game image on two mobile terminals.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a wired or wireless interface between a master mobile terminal and a slave mobile terminal according to the present invention;

FIG. 2A illustrates the display of an image on a single mobile terminal; FIG. 2B illustrates the divided display of the same image on two mobile terminals;

FIG. 3 is a block diagram showing the inner structures of a master mobile terminal and a slave mobile terminal according to the present invention; and

FIG. 4 is a flow chart showing a process of dividing an image and displaying the divided image on two mobile terminals according to the present invention.

### DETAILED DESCRIPTION OF THE PREFERRED EMBODIMENT

Hereinafter, preferred embodiments of the present invention will be described with reference to the accompanying drawings. In the drawings, the same element, although depicted in different drawings, will be designated by the same reference numeral or character. In addition, a detailed description of known functions and configurations incorporated herein will be omitted when it may make the subject matter of the present invention unclear.

Although a method for dividing an image into two to be displayed on two respective mobile terminals will be explained, it is also possible to divide a single image into three or more pieces to be displayed on three or more mobile terminals according to the present invention.

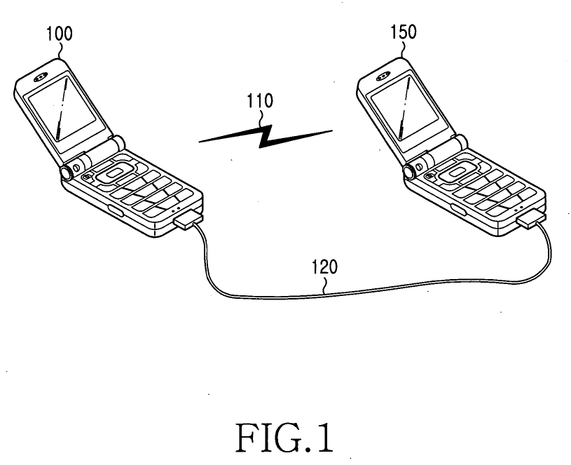

FIG. 1 is a perspective view illustrating a master mobile terminal and a slave mobile terminal according to the present invention. Referring to FIG. 1, a master mobile terminal 100 and a slave mobile terminal 150 are connected to each other via a wireless interface link 110 or a wired interface link 120 to receive or transmit image data. For the image data transmission between the master mobile terminal 100 and the slave mobile terminal 150, each terminal has an interface which includes a wired interface 120 implemented by a serial port, a USB port, a wired LAN port or the like and a wireless interface 110 implemented by a wireless LAN port, a Bluetooth port, an IrDA port or the like. The master and slave mobile terminals can exchange image data through a wired/wireless interface. Each terminal has one or more interfaces so that the user can select and set a specific wired or wireless interface.

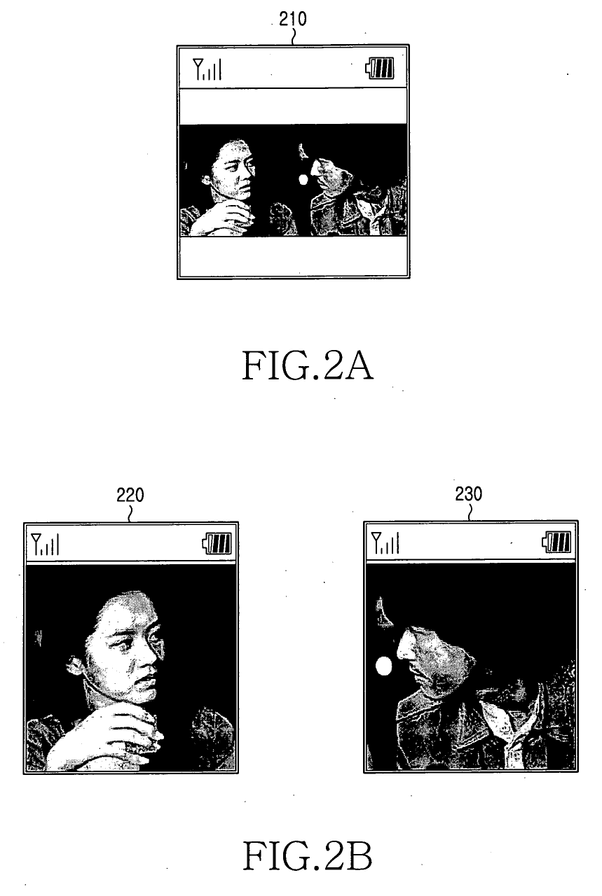

The master mobile terminal 100 divides an image into two and displays one half of the image on a display window 220 as shown in FIG. 2B. The master mobile terminal 100 sends the other half of the image to the slave mobile terminal 150 so that the other half can be displayed on a display window 230 of the slave mobile terminal 150. An image can be displayed as a whole on a display window 210 of a single mobile terminal as shown in FIG. 2A. The image can be divided to be displayed on two separate mobile terminals as shown in FIG. 2B.

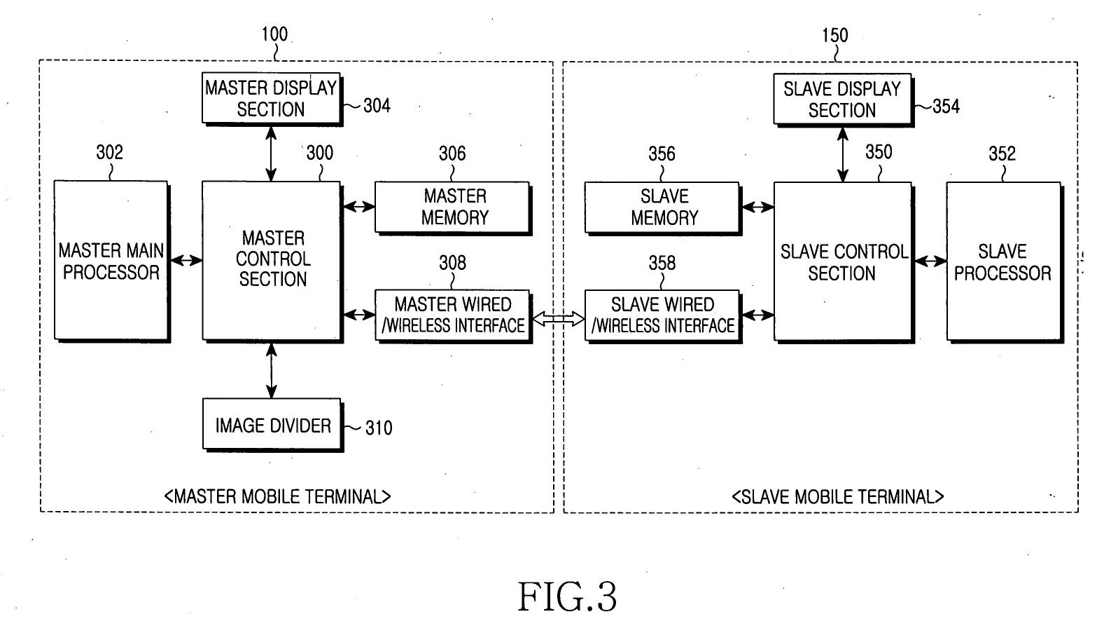

FIG. 3 is a block diagram showing the inner structures of the master mobile terminal 100 and the slave mobile terminal 150 according to the present invention. Both terminals commonly include a control section 300/350, a main processor 302/352, a display section 304/354, a memory 306/356 and a wired/wireless interface 308/358. The master mobile terminal 100 further includes an image divider 310 for dividing an image.

In the master mobile terminal 100, a master main processor 302 performs fundamental functions of telephone calls and wireless communications through a wireless network. The master main processor 302 includes an RF section, a key input section and an audio processor. The RF section performs a wireless communication function of the mobile terminal. The key input section provides a keypad for the interface with the user. The audio processor processes audio data. The master main processor 302 can process wireless incoming and outgoing calls through the operations of the above sections. Since those sections of the master main processor 302 are generally known in the art, no detailed explanation will be made with respect to the operations of the sections.

A master display section 304 for displaying image data output from the master mobile terminal 100 may be implemented by an LCD. When an image is divided into a master image and a slave image by an image divider 310, the master image provided from the image divider 310 is displayed on the master display section 304.

A master memory 306 stores operating system (OS) and operating programs, administrator data, user data, various algorithms and data necessary for the operation of the mobile terminal. The master memory 306 also stores multimedia data, such as image data and audio data, as a media reproduction source.

A master wired/wireless interface 308 provides a wired/wireless link for the data communication between the master mobile terminal 100 and the slave mobile terminal 150. When an image is divided to generate a master image and a slave image, the master wired/wireless interface 308 receives the slave image from a master control section 300 and sends the slave image to a slave wired/wireless interface 358 according to the interface protocol used. The slave wired/wireless interface 358 transfers the received slave image to a slave control section 350 which will then control a slave display section 354 to display the slave image. The master wired/wireless interface 308 can be either a wired interface (such as a wired LAN port, a serial port or a USB port) or a wireless communication interface (such as a wireless LAN port, a Bluetooth port or an IrDA port). To implement a wired or wireless interface, a corresponding standard protocol should be provided. For example, a serial port or a Bluetooth port can be implemented according to RS-232 or a standard Bluetooth protocol. The master wired/wireless interface 308 may include a plurality of wired interfaces and wireless interfaces so that the user can select and set a specific interface between the master mobile terminal 100 and the slave mobile terminal 150.

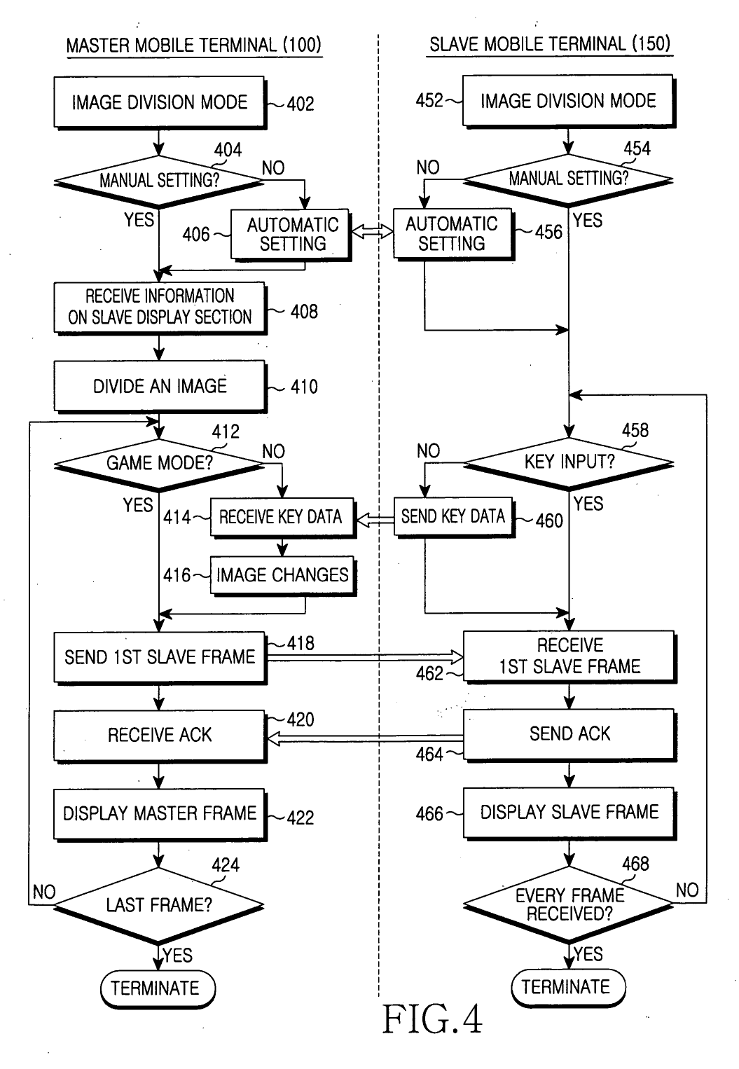

The image divider 310 divides an image into two parts to generate a master image and a slave image which will be displayed on the master display section 304 and the slave display section 354, respectively. The slave image is converted and regenerated to conform to the size and number of colors of the slave display section 354. In this regard, the master control section 300 provides information on the slave display section 354, including the size and the number of colors, to the image divider 310. The image divider 310 regenerates the slave image based on the information received from the master control section 300. The process of generating a master image and a slave image will be explained in detail with reference to the flow chart in FIG. 4.

The master control section 300 controls the operation of each section of the master mobile terminal 100. The master control section 300 transfers a master image generated by the image divider 310 to the master display section 304 and a slave image to the slave mobile terminal 150 via the master wired/wireless interface 308.

The slave mobile terminal 150, when connected to the master mobile terminal 100 via a wired/wireless link, receives the slave image from the master mobile terminal 100 and displays the received slave image. The slave mobile terminal 150 includes a slave main processor 352, a slave display section 354, a slave memory 356, a slave wired/wireless interface 358 and a slave control section 350. Like the master main processor 302, the slave main processor 352 includes an RF section for wireless communications, a key input section and an audio processor. Since the slave main processor 352 is generally known to process wireless incoming and outgoing calls and has the same functions as implemented by the master main processor 302, no detailed explanation thereof will be made.

The slave display section 354, which can be implemented by an LCD, displays the slave image received from the master mobile terminal 100. The slave memory 356 stores OS and operating algorithms for the operation of the slave mobile terminal 150, operating data and user data. When the slave image is displayed on the slave display section 354, it can also be temporarily stored in a temporary buffer included in the slave memory 356. The slave image stored in the temporary buffer of the slave memory 356 can be transferred to and displayed on the slave display section 354 whenever requested by the user.

The slave wired/wireless interface 358 for the communication link to the master wired/wireless interface 308 can be a variety of wired or wireless ports, including USB and Bluetooth. However, for the data communication with the master wired/wireless interface 308, the slave wired/wireless interface 358 should be a communication interface having the same protocol as used in the communication port of the master wired/wireless interface 308. For example, when the master wired/wireless interface 308 is implemented by a Bluetooth port, the slave wired/wireless interface 358 should also be implemented by a Bluetooth port.

FIG. 4 is a flow chart showing a process of dividing an image to be displayed on a master mobile terminal and a slave mobile terminal according to the present invention.

The users of the master mobile terminal 100 and the slave mobile terminal 150 can select an image division mode at step 402 or 452, respectively. The image division mode refers to a mode for dividing an image into at least two parts and displaying the two parts of the divided image on separate (master and slave) mobile terminals. While a master image, one half of the original image, is displayed on the display section of the master mobile terminal 100, a slave image, the other half of the original image, is sent to the slave mobile terminal 150 and displayed on the display section of the slave mobile terminal 150. Although the image is described as being divided is half, the present invention contemplates division in parts other than equal parts.

In the image division mode, a communication link between the master mobile terminal 100 and the slave mobile terminal 150 is set at steps 404, 454, 406 and 456. The communication link determines the method of data transmission between the two terminals. As explained above, the same communication link should be set on the two terminals. The communication link can be set manually at steps 404 and 454 or automatically at steps 406 and 456.

At steps 404 and 454, the users can manually set the communication link by directly selecting a data transmission method from a menu displayed on their mobile terminals. The users may set a specific wired communication link, such as USB or wired LAN, between the two mobile terminals. Alternatively, the users may set a wireless communication link when they wish to perform a short-range wireless communication, such as Bluetooth or IrDA communication.

At steps 406 and 456, the communication link between the two terminals is automatically set, without the need to be manually set by the users. For example, when a USB line is provided between the two terminals, the master mobile terminal detects the USB link and sends a defined slave ID to a mobile terminal that can be a slave. Upon receiving the slave ID, the slave mobile terminal enters the image division mode and sends an ACK signal to the master mobile terminal. When a short-range wireless communication, such as Bluetooth, is used for the data transmission between the two terminals, the master mobile terminal detects any accessible slave mobile terminal at predetermined intervals and sends information about the communication link to a detected slave mobile terminal.

After the communication link setting steps, the master mobile terminal receives information about the slave display section (for example, LCD size and colors) at step 408. The user of the master mobile terminal may directly input the information on the slave display section. Alternatively, the slave mobile terminal may provide the information on the slave display section in response to the request from the master mobile terminal.

Since the master mobile terminal and the slave mobile terminal can be different types of terminals having different window sizes and colors, the information on the slave display section is needed to better fit the divided image to the window specifications of the two terminals. Based on the information on the slave display section, the master mobile terminal sets a slave image to conform to the size and colors of the slave display section.

In other words, the master mobile terminal generates a slave image based on the information on the slave display section, such as the window size (for example, LCD size of 128×1 50, 320×240) and the number of colors (for example, 65 k, 260 k), which has been inputted directly by the user or received from the slave mobile terminal. Accordingly, even if the master mobile terminal and the slave mobile terminal are different types, they can effectively display the divided image. When different types of mobile terminals are used for the divided display of an image, a data format should be changed in a slave mobile terminal. Such a change in data format may influence the data transmission rate and deteriorate the capacity of the mobile terminal. Therefore, it is preferable to use mobile terminals having display windows of similar specifications and control sections with similar capacities in order to reduce any delay in the divided display of an image.

After receiving the information on the slave display section at step 408, the master mobile terminal proceeds with dividing an image into two at step 410.

The image division is performed by the image divider. The image divider 310 counts the number of pixels (the number of horizontal pixels×the number of vertical pixels) in an image and divides the image into two (i.e. a master image and a slave image) at the center pixel in a horizontal or vertical direction. For example, an image having N×M pixels is divided into two at a center pixel (N/2, M/2). One half of the divided image is a master image which will be displayed on the master mobile terminal 100. The other half is a slave image which will be displayed on the slave mobile terminal 150. The slave image is generated according to the information on the slave display section. In other words, the slave image is generated to have the same size and colors as included in the information on the slave display section. But, as stated earlier, divisions other then one-half are contemplated.

After generating the master image and the slave image from the original image, image changes are carried out according to the key inputs by the users at steps 412, 414 and 416. To be specific, when the user of the slave mobile terminal 150 presses a key at step 458 during the display of a mobile game image, corresponding key data is sent to the master mobile terminal at step 460. The master mobile terminal receives the key data at step 414 and generates an image corresponding to the received key data at step 416. Since the slave mobile terminal is also involved in the operations necessary to play a mobile game, it is necessary to send all key data input at the slave mobile terminal in the game mode to the master mobile terminal at step 460. The master mobile terminal divides a mobile game image into two one of which is displayed on each of the master mobile terminal and the slave mobile terminal. The game characters or items (for example, planes or tanks) in the displayed image are changed or moved according to key inputs from the master or slave mobile terminal. Unlike a single-player game played on one mobile terminal, a 2-player game played on two mobile terminals is controlled by both inputs from the master mobile terminal and the slave mobile terminal. The master mobile terminal receives every key input from the slave mobile terminal to change or move the characters or items in the displayed image. The slave mobile terminal sends all key input data to the master mobile terminal during a 2-player mobile game so that the master mobile terminal can control the movement or change of characters or items in the displayed game image.

When a picture, still image or moving image such as movie, rather than a mobile game image, is divided and displayed on the two mobile terminals, the master mobile terminal sends a slave image generated from the original picture or image to the slave mobile terminal at step 418, regardless of any key input from the slave mobile terminal.

Through steps 418, 420, 422 and 424, the master mobile terminal sends a synchronized image to the slave mobile terminal. Synchronization is carried out to simultaneously display the master and slave images on the two mobile terminals. If the master and slave images are not synchronized, there will be problems in viewing a single original image using two mobile terminals. Both the master image and the slave image consist of a plurality of frames. In the following explanation of synchronization, a master frame refers to one of the plurality of frames of the master image. A slave frame refers to one of the plurality of frames of the slave image.

When a first slave frame, i.e. the first frame of the slave image generated by the master mobile terminal 100, is sent to the slave mobile terminal 150 from the master mobile terminal 100 at step 418, the slave mobile terminal 150 confirms the last bit of the first slave frame received at step 462 and sends an ACK signal acknowledging the receipt of the first slave frame to the master mobile terminal 100 at step 464. Upon receiving the ACK signal at step 420, the master mobile terminal displays a first master frame corresponding to the first slave frame on the master display section at step 422. The slave mobile terminal also displays the first slave frame at step 466 immediately after sending the ACK signal. Then each terminal confirms whether the displayed frame is the last one of the image at steps 424 and 468. If not, the master mobile terminal will proceed again with step 418 to send a next slave frame to the slave mobile terminal. The steps of sending and displaying a frame are repeated until the last master and slave frames are displayed. Through these steps, master-slave synchronization can be achieved on the two mobile terminals.

If the master mobile terminal displays a master frame immediately upon receiving an ACK signal and the slave mobile terminal displays a slave frame immediately after sending the ACK signal, there will be a slight difference of 2 to 3 clocks based on a system clock. As one clock in a system operating at 50 MHz is 20 ns, 2 to 3 clocks correspond to 40 to 60 ns. Such a clock difference is hardly perceptible by human eye. Accordingly, two corresponding frames appear to be simultaneously displayed on the two mobile terminals with almost perfect synchronization. It would be necessary to measure the time taken to send and receive one bit between the two mobile terminals. More precise synchronization can be achieved if the slave mobile terminal waits for the delay time after sending an ACK signal and then displays a slave frame. This method, however, will be effectively applied to systems operating at a low speed.

When the master mobile terminal and the slave mobile terminal are connected by a wired communication link, a separate interrupt pin can be used as an ACK signal line. Upon receiving one frame data, the slave mobile terminal generates an interrupt to inform the master mobile terminal of the receipt so that the master mobile terminal and the slave mobile terminal can simultaneously display two corresponding frames. Although the separate interrupt pin may complicate the hardware, it can ensure reliability in synchronized display.

As explained above, dividing the display of an image between two mobile terminals can be achieved by repeating steps of sending and displaying a frame until the last master and slave frames are displayed.

Although a process of dividing an image into two and displaying the two parts on two mobile terminals has been explained above, it is also possible to divide an image into N pieces and display the N pieces on N mobile terminals.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A system for divided display of an image using a plurality of mobile terminals, comprising:
a master mobile terminal having an image divider for dividing an image into at least two pieces, displaying one of the pieces as a master image on a master display section thereof and transmitting each remaining piece as a slave image; and
at least one slave mobile terminal for receiving the slave image from the master mobile terminal and displaying the received slave image on a slave display section thereof;
wherein said master mobile terminal includes a master wired/wireless interface for providing a protocol and hardware necessary for data communications with said slave mobile terminal,
wherein said slave mobile terminal includes and a slave wired/wireless interface for providing a protocol and hardware necessary for data communications with the master mobile terminal.

2. The system as claimed in claim 1, wherein said master wired/wireless interface and said slave wired/wireless interface are implemented by one of a wired communication port, and a wireless communication port.

3. The system as claimed in claim 1, wherein said image divider included in the master mobile terminal generates a slave image based on information on window size and colors of the slave display section.

4. A method for producing a divided display of an image using a plurality of mobile terminals, which comprises the steps of:
setting one of a wired and a wireless communication link between a master mobile terminal and a slave mobile terminal;
providing to the master mobile terminal information about a slave display of the slave mobile terminal;
dividing an image to generate a master image to be displayed on the master mobile terminal and a slave image to be displayed on the slave mobile terminal; and
sequentially displaying frames of the master image on the master mobile terminal and at the same time sending frames of the slave image to the slave mobile terminal, synchronizing the sequentially received frames of the slave image with the frames of the master image and sequentially displaying the synchronized frames.

5. The method as claimed in claim 4, wherein said communication link is selected by a user.

6. The method as claimed in claim 4, wherein said information about the slave display includes the window size and number of colors of the slave display section which are directly input by a user.

7. The method as claimed in claim 4, wherein said information about the slave display is provided from the slave mobile terminal to the master mobile terminal when requested.

8. The method as claimed in claim 4, wherein said slave image is generated based on the information about the slave display section.

9. The method as claimed in claim 4, wherein said synchronization includes:
dividing the master image and the slave image to generate master frames and slave frames and sending a first slave frame which is the first frame of the slave image to the slave mobile terminal;
displaying the first slave frame received from the master mobile terminal on the slave mobile terminal and sending an ACK signal acknowledging the receipt of the first slave frame to the master mobile terminal; and
upon receiving the ACK signal, displaying a first master frame corresponding to the first slave frame on the master mobile terminal.

10. The method as claimed in claim 9, wherein said ACK signal is sent and received through a dedicated interrupt line provided when the master mobile terminal and the slave mobile terminal are connected via a wired link.
